(19) United States
(12) Patent Application Publication
(10) Pub. No.: US 2026/0219604 A1
(43) Pub. Date: Jul. 30, 2026

(54) ELECTROPHOTOGRAPHIC MEMBER, TRANSFER DEVICE, IMAGE FORMING APPARATUS, AND METHOD OF FORMING SURFACE LAYER OF ELECTROPHOTOGRAPHIC MEMBER

(71) Applicant: FUJIFILM Business Innovation Corp., Tokyo (JP)

(72) Inventors: Kenji KAJIWARA, Kanagawa (JP); Iori NISHIMURA, Kanagawa (JP); Kenji OMORI, Kanagawa (JP); Minoru ROKUTAN, Kanagawa (JP); Jun KIMURA, Kanagawa (JP); Masato ONO, Kanagawa (JP); Masayuki SEKO, Kanagawa (JP)

(73) Assignee: FUJIFILM Business Innovation Corp., Tokyo (JP)

(21) Appl. No.: 19/420,747

(22) Filed: Dec. 16, 2025

(30) Foreign Application Priority Data
Jan. 24, 2025 (JP) 2025-010968
Oct. 8, 2025 (JP) 2025-170438

(51) Int. Cl. G03G 15/16; G03G 7/00

(52) U.S. Cl. CPC G03G 15/1685; G03G 7/0046; G03G 7/0053; G03G 15/162

(57) ABSTRACT

An electrophotographic member includes a surface layer that contains no fluorine material, in which, in a case where air is blown onto a surface of the surface layer from an upper side of the surface of the surface layer while a blowing pressure is increased after polyester resin particles having a volume average particle diameter of 4.7 μm are attached to the surface of the surface layer, all of the polyester resin particles attached to the surface of the surface layer are separated from the surface of the surface layer at a blowing pressure of 6 kPa or less.

### CROSS-REFERENCE TO RELATED APPLICATIONS

This application is based on and claims priority under 35 USC 119 from Japanese Patent Application No. 2025-170438 filed Oct. 8, 2025 and Japanese Patent Application No. 2025-010968 filed Jan. 24, 2025.

### BACKGROUND

### (i) Technical Field

The present invention relates to an electrophotographic member, a transfer device, an image forming apparatus, and a method of forming a surface layer of an electrophotographic member.

### (ii) Description of Related Art

In an image forming apparatus (such as a copy machine, a facsimile machine, and a printer) using an electrophotographic method, a toner image formed on a surface of an image holder is transferred to a transfer member, and fixed on a recording medium such that an image is formed.

For example, JP2004-212540A discloses “electrophotographic toner in which a ratio (F/D) of an average value F of centrifugal force before and after a toner is detached to a volume average particle diameter D (m) of the detached toner is 4.5 nN/μm or less”.

JP2008-112203A discloses “intermediate transfer body in which a toner adhesiveness-reducing layer that reduces toner adhesiveness on a surface is uniformly formed”.

### SUMMARY

Aspects of non-limiting embodiments of the present disclosure relate to an electrophotographic member that can suppress contamination of a recording medium in an electrophotographic member including a surface layer that contains no fluorine material, as compared to a case where a blowing pressure described later is more than 6 kPa and all polyester resin particles attached are separated from the surface layer.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Methods for achieving the above-described object include the following aspects.

According to an aspect of the present disclosure, there is provided an electrophotographic member including:
a surface layer that contains no fluorine material,
in which, in a case where air is blown onto a surface of the surface layer from an upper side of the surface of the surface layer while a blowing pressure is increased after polyester resin particles having a volume average particle diameter of 4.7 μm are attached to the surface of the surface layer, all of the polyester resin particles attached to the surface of the surface layer are separated from the surface of the surface layer at a blowing pressure of 6 kPa or less.

### BRIEF DESCRIPTION OF THE DRAWINGS

Exemplary embodiment(s) of the present invention will be described in detail based on the following figures, wherein:

FIG. 1 is a view schematically showing a configuration of an example of the image forming apparatus according to the present exemplary embodiment; and

FIG. 2 is a view schematically showing a configuration of a vicinity of a secondary transfer unit in another example of the image forming apparatus according to the present exemplary embodiment.

### DETAILED DESCRIPTION

Hereinafter, exemplary embodiments of the present invention will be described. The following descriptions and examples merely illustrate the exemplary embodiments, and do not limit the present invention.

Regarding the numerical ranges described in stages in the present specification, the upper limit value or lower limit value of a numerical range may be replaced with the upper limit value or lower limit value of another numerical range described in stages. In addition, in the present specification, the upper limit value or lower limit value of a numerical range may be replaced with values described in examples.

In the present specification, the term “step” includes not only an independent step but a step which is not clearly distinguished from other steps as long as the intended purpose of the step is achieved.

In the present specification, in a case where an exemplary embodiment is described with reference to drawings, the configuration of the exemplary embodiment is not limited to the configuration shown in the drawings. In addition, the sizes of members in each drawing are conceptual and do not limit the relative relationship between the sizes of the members.

In the present specification, each component may include a plurality of corresponding substances. In the present specification, in a case of referring to an amount of each component in the composition, the amount refers to a total amount of the substances that are present in the composition.

### Electrophotographic Member

The electrophotographic member according to the present exemplary embodiment includes a surface layer that contains no fluorine material.

The surface layer has a property that, in a case where air is blown onto a surface of the surface layer from an upper side of the surface of the surface layer while a blowing pressure is increased after polyester resin particles having a volume average particle diameter of 4.7 μm are attached to the surface of the surface layer, all of the polyester resin particles attached to the surface of the surface layer are separated from the surface of the surface layer at a blowing pressure of 6 kPa or less.

Hereinafter, the “characteristic that all the polyester resin particles attached to the surface of the surface layer are separated from the surface of the surface layer at a blowing pressure of 6 kPa or less” is also referred to as “adhesiveness characteristic”.

In addition, the “fluorine material” means “material including a fluorine atom”.

The electrophotographic member according to the present exemplary embodiment can suppress contamination of a recording medium by the above-described configuration. The reason is as follows.

In recent years, due to the increasing awareness of sustainable development goals (SDGs), developments of materials that reduce environmental burden have been in progress. As one of the examples, a technique of not using a fluorine material having high release properties is considered.

However, in the electrophotographic member including the surface layer that contains no fluorine material as a release agent, the release properties are not sufficient. Therefore, in a case where a toner is attached to the surface layer due to toner scattering (so-called toner cloud) occurring during transfer of a toner image, the toner is difficult to be cleaned. The toner adhesion causes the contamination of the recording medium.

On the other hand, the electrophotographic member according to the present exemplary embodiment is a member in which the surface layer satisfies the above-described adhesiveness characteristic even in a case where the surface layer does not contain a fluorine material. That is, non-electrostatic adhesiveness of the surface layer itself is reduced, and thus the release properties are high. As a result, even in a case where the toner is attached to the surface layer, the toner is easily cleaned. As a result, the contamination of the recording medium is suppressed.

As described above, the electrophotographic member according to the present exemplary embodiment suppresses the contamination of the recording medium.

Details of the electrophotographic member according to the present exemplary embodiment will be described.

The electrophotographic member according to the present exemplary embodiment includes a surface layer that contains no fluorine material.

Examples of the electrophotographic member include a member that includes at least one of a resin layer or an elastic layer below the surface layer. Specifically, examples of the electrophotographic member include members shown in (1) to (4).
(1) A member including a resin layer and a surface layer in this order
(2) A member including an elastic layer and a surface layer in this order
(3) A member including a resin layer, an elastic layer, and a surface layer in this order
(4) A member including an elastic layer, a resin layer, and a surface layer in this order

### Surface Layer

### Adhesiveness Characteristic

The surface layer has a characteristic in which, in a case where air is blown onto a surface of the surface layer from an upper side of the surface of the surface layer while a blowing pressure is increased after polyester resin particles having a volume average particle diameter of 4.7 μm are attached to the surface of the surface layer, all of the polyester resin particles attached to the surface of the surface layer are separated from the surface of the surface layer at a blowing pressure of 6 kPa or less.

In a case where the surface layer satisfies the above-described adhesiveness characteristic, even in a case where the toner is attached to the surface layer, the toner is easily cleaned. As a result, the contamination of the recording medium is suppressed.

From the viewpoint of improving the suppression of the contamination of the recording medium, for example, the surface layer preferably has a characteristic in which all the polyester resin particles attached to the surface layer are separated from the surface layer at a blowing pressure of 4 kPa or less, and more preferably has a characteristic in which all the polyester resin particles attached to the surface layer are separated from the surface layer at a blowing pressure of 2 kPa or less.

Here, the determination as to whether or not the surface layer satisfies the adhesiveness characteristic is performed as follows.

First, a sample piece that is 3 cm×4 cm square and includes the surface layer is collected from the electrophotographic member to be evaluated.

Next, in an environment of 22° C. and 15%, polyester resin particles are scattered from above a height of 15 cm onto a measurement surface corresponding to the surface of the surface layer in the sample piece in a state in which a voltage of 10 kV is applied horizontally to the measurement surface, and the polyester resin particles are attached at a loading amount of 3 g/cm².

Here, as the polyester resin particles, resin particles that are a polycondensate of dimethyl fumarate, that is a dicarboxylic acid, and propylene glycol, that is a diol, are applied. A weight-average molecular weight of the resin in the resin particles is 25,000. A volume average particle diameter of the resin particles is 4.7 μm.

As the polyester resin particles, uncharged resin particles are applied. The uncharged resin particles mean particles having a charging amount of 5 μC/g or less in absolute value.

Next, from an air blowing port having a diameter of 0.7 mm placed 3 cm above a central portion of the surface of the sample piece to which the polyester resin particles have adhered, air is started to be blown in the central portion at a blowing pressure of 0.1 kPa, and the blowing pressure is increased at 0.5 kPa/sec.

In a case where all the polyester resin particles are spaced apart from the sample piece at a point in time when the blowing pressure has reached 6 kPa, it is determined that the adhesiveness characteristic is satisfied.

On the other hand, in a case where the polyester resin particles remain on the sample piece even though the blowing pressure exceeds 6 kPa, it is determined that the adhesiveness characteristic is unsatisfied.

Here, the weight average molecular weight of the polyester resin particles is measured by gel permeation chromatography (GPC). In the molecular weight measurement by GPC, GPC HLC-8120GPC manufactured by Tosoh Corporation is used as a measurement device. In the molecular weight measurement, a column TSKgel SuperHM-M (15 cm) manufactured by Tosoh Corporation is used. The molecular weight measurement is performed in a THF solvent. The weight-average molecular weight is calculated using a molecular weight calibration curve created by a monodisperse polystyrene standard sample based on the measurement results.

In addition, the volume average particle diameter of the polyester resin particles is measured as follows. In the measurement, a Coulter Multisizer II (manufactured by Beckman Coulter, Inc.) is used. As an electrolytic solution, ISOTON-II (manufactured by Beckman Coulter, Inc.) is used.

For measurement, a measurement sample in an amount of 0.5 mg or more and 50 mg or less is added to 2 ml of a 5% aqueous solution of a surfactant (for example, preferably sodium alkylbenzene sulfonate) as a dispersant. The obtained solution is added to an electrolytic solution in a volume of 100 ml or more and 150 ml or less.

The electrolytic solution in which the sample is suspended is subjected to a dispersion treatment for 1 minute with an ultrasonic disperser. Thereafter, a particle size distribution of particles having a particle diameter in a range of 2 μm or more and 60 μm or less is measured by the Coulter Multisizer II using an aperture of 100 μm as an aperture diameter. The number of particles to be sampled is 50,000.

Based on the measured particle size distribution, the volume is measured by drawing a cumulative distribution from the smaller diameter side for each of the particle size ranges (channels) divided. In the cumulative distribution, a particle diameter at which a cumulative value is 50% is defined as a volume average particle diameter D50v.

In addition, the charging amount of the polyester resin particles is measured using a blow-off powder charging amount measuring device (TB-200) manufactured by Tosoh Corporation in an environment of 22° C. and 15%.

### Formulation

For example, the surface layer contains a binding material and the polysiloxane compound particles. The surface layer may contain a conductive agent, other additives, and the like.

### Polysiloxane Compound Particles

As the polysiloxane compound particles, for example, it is preferable to apply polysiloxane compound particles having the T unit represented by the formula: [R¹SiO^{3/2}]ₘ (in the formula, R¹ represents an organic group, m represents an integer of 2 or more, and at least one R¹ among a plurality of R¹'s present in the T unit is a group including at least one of an alkyl group or an aryl group).

By applying the polysiloxane compound particles, the above-described adhesiveness characteristic can be easily imparted even without applying a fluorine material.

The polysiloxane compound particles may be a polysiloxane compound having a D unit represented by a formula: (R²R³SiO_{2/2})ₙ (in the formula, R² and R³ are organic groups, and n is an integer of 2 or more), together with the T unit represented by the formula: [R¹SiO_{3/2}]ₘ.

For example, it is preferable that at least one of R² or R³ among a plurality of R²'s and R³'s present in the D unit is a group including at least one of an alkyl group or an aryl group.

In the T unit and the D unit, the organic group of R¹, R², and R³ in the formulae represents, for example, a hydroxyl group, a siloxy group, a hydrocarbon group, a hydrocarbon group in which one or a plurality of methylene groups are replaced with a carbonyl group, a hydrocarbon group in which one or a plurality of carbon atoms are replaced with a heteroatom (an oxygen atom, a nitrogen atom, or a sulfur atom), or a group obtained by combining these groups.

Examples of the siloxy group described as the organic group represented by R¹, R², and R³ include a monoalkylsiloxy group, a dialkylsiloxy group, and a trialkylsiloxy group; and for example, a dialkylsiloxy group or a trialkylsiloxy group is preferable, and a trialkylsiloxy group is more preferable.

Examples of the hydrocarbon group described as the organic group represented by R¹, R², and R³ include an aliphatic hydrocarbon group and an aromatic hydrocarbon group.

Examples of the aliphatic hydrocarbon group include a linear, branched, or alicyclic saturated aliphatic hydrocarbon group, and a linear, branched, or alicyclic unsaturated aliphatic hydrocarbon group.

The aliphatic hydrocarbon group is, for example, preferably a hydrocarbon group having 1 or more and 20 or less carbon atoms, and more preferably a hydrocarbon group having 1 or more and 15 or less carbon atoms.

The aliphatic hydrocarbon group may be substituted with a substituent such as a halogen atom, a hydroxyl group, an amino group, and an aryl group.

Examples of the aromatic hydrocarbon group include a hydrocarbon group having 6 or more and 18 or less carbon atoms (for example, preferably 6 or more and 14 or less carbon atoms). Examples of the aromatic hydrocarbon group include a phenyl group, a naphthyl group, and an anthracenyl group.

The aromatic hydrocarbon group may be substituted with a substituent such as a halogen atom, a hydroxyl group, an amino group, an alkyl group, and an alkoxy group.

The organic group represented by R¹, R², and R³ may have a reactive group. Examples of the reactive group include a vinyl group, an allyl group, a styryl group, a maleimide group, an epoxy group, and a (meth)acryloyl group. That is, the polysiloxane compound particles may be cured particles in which the above-described reactive group is reacted.

From the viewpoint of flexibility of the polysiloxane compound particles, for example, it is preferable that the organic groups represented by R¹, R², and R³ do not include a reactive group.

A plurality of R¹'s, R²'s, and R³'s present in the T unit and the D unit may be the same organic group or different organic groups.

However, at least one R¹ among the plurality of R¹'s present in the T unit is a group including at least one of an alkyl group or an aryl group.

In addition, at least one R² or R³ among the plurality of R²'s and R³'s present in the D unit is, for example, preferably a group including at least one of an alkyl group or an aryl group.

That is, at least one R¹ among the plurality of R¹'s present in the T unit is a group including at least one of an alkyl group or an aryl group.

For example, it is preferable that at least one R² among the plurality of R²'s present in the D unit is a group including at least one of an alkyl group or an aryl group.

For example, it is preferable that at least one R³ among the plurality of R³'s present in the D unit is a group including at least one of an alkyl group or an aryl group.

Here, from the viewpoint of improving the adhesiveness characteristic, as the group including an alkyl group, for example, an alkyl group itself or a siloxy group including an alkyl group is preferable. That is, at least one of R¹'s present in plurality in the T unit or R²'s and R³'s present in plurality in the D unit is, for example, preferably an alkyl group or a siloxy group including an alkyl group.

From the viewpoint of improving the adhesiveness characteristic, the alkyl group is, for example, preferably an alkyl group having 1 or more and 6 or less carbon atoms, and more preferably an alkyl group having 1 or more and 4 or less carbon atoms or an alkyl group having 1 carbon atom (that is, a methyl group).

As the group including an aryl group, for example, an aryl group itself or an aralkyl group is preferable.

Examples of the aryl group include a phenyl group and a naphthyl group.

Examples of an alkyl group in the aralkyl group include a linear or branched alkyl group having 1 or more and 4 or less carbon atoms. Examples of an aryl group in the aralkyl group include a phenyl group and a naphthyl group. Examples of the aralkyl group include a benzyl group, a 1-phenylethyl group, a 2-phenylethyl group, and a 2-methyl-2-phenylethyl group.

From the viewpoint of improving the adhesiveness characteristic, as the group including an aryl group, for example, a phenyl group is preferable.

From the viewpoint of improving the adhesiveness characteristic, for example, it is preferable that a presence proportion of the group including at least one of an alkyl group or an aryl group is high with respect to the polysiloxane compound particles.

In the T unit and the D unit, m and n in the formulae represent an integer of 2 or more; and from the viewpoint of improving the adhesiveness characteristic, for example, an integer of 8 or more is preferable, and an integer of 8 or more and 10,000 or less is more preferable.

In the T unit and the D unit, the upper limit of a ratio m/n of m and n in the formulae is, for example, preferably 100/0 or less, and more preferably 100/1 or less. In addition, the lower limit of m/n is, for example, preferably 10/90 or more, more preferably 20/80 or more, and still more preferably 25/75 or more.

The ratio m/n, that is, the ratio of the T unit and the D unit is measured as follows. The ratio m/n is calculated based on the peak ratio of the D unit (high ppm side) and the T unit (low ppm side) by solid ²⁹Si NMR.

A content of the polysiloxane compound particles with respect to the surface layer is, for example, preferably 3% by volume or more and 50% by volume or less, more preferably 6% by volume or more and 40% by volume or less, and still more preferably 10% by volume or more and 37% by volume or less.

In a case where the content of the polysiloxane compound particles is 3% by volume or more, the adhesiveness characteristic is improved.

In a case where the content of the polysiloxane compound particles is 50% by volume or less, decrease in bending resistance of the surface layer is suppressed.

A volume average particle diameter of the polysiloxane compound particles is, for example, preferably 0.01 μm or more and 10 μm or less, more preferably 0.01 μm or more and 5 μm or less, and still more preferably 0.01 μm or more and 2.5 μm or less. The volume average particle diameter of the polysiloxane compound particles is, for example, particularly preferably 3.0 μm or less, and more preferably 1.0 μm or less.

In a case where the volume average particle diameter of the polysiloxane compound particles is within the above-described range (particularly, 3.0 μm or less), the polysiloxane compound particles are likely to be uniformly dispersed on the surface layer. As a result, the adhesiveness characteristic is improved, and the contamination of the recording medium is likely to be suppressed.

The volume average particle diameter of the polysiloxane compound particles is measured as follows.

A sample is collected from the surface layer. The sample is a sample in which a cut surface along a thickness direction of the surface layer is used as an observation surface.

The observation surface of the sample is observed with a scanning electron microscope to capture an image. In the image, an area of each primary particle of the polysiloxane compound particles is measured by image analysis, and an equivalent circle diameter thereof is calculated from this area value. The calculation of the equivalent circle diameter is carried out for 100 particles of the polysiloxane compound particles. A 50% diameter (D50v) in the volume-based cumulative frequency of the obtained equivalent circle diameter is defined as the volume average particle diameter of the polysiloxane compound particles.

Examples of the polysiloxane compound particles include polymer compound particles referred to as silsesquioxane (SQ) having various skeleton structures.

The polysiloxane compound particles may have, as a skeleton structure, any of a cage-type structure (a perfect cage-type structure or a cage-type structure), a ladder-type structure, or a random structure.

### Binding Material

Examples of the binding material include a polyamide resin, a polyurethane resin, a polyester resin, a polyimide resin, a silicone resin, an acrylic resin, a polyvinyl butyral resin, a melamine resin, an epoxy resin, a polycarbonate resin, a polyvinyl alcohol resin, a cellulose resin, a polyvinylidene chloride resin, a polyvinyl chloride resin, a polyethylene resin, and an ethylene-vinyl acetate copolymer resin.

In particular, as the binding material, for example, a urethane resin is preferable. The urethane resin may be an acrylic urethane resin, a polyester polyurethane resin, a polyether polyurethane resin, or the like. Among these, as the urethane resin, for example, a silicone-modified urethane resin is preferable, and a silicone-modified acrylic urethane resin is more preferable.

A content of the binding material is an amount of the principal component of the surface layer. Here, the amount of the principal component of the surface layer means an amount of the most abundant component among the components contained in the surface layer, excluding the polysiloxane compound particles.

### Conductive Agent

Examples of the conductive agent include carbon black, metals (for example, aluminum, nickel, or the like), a metal oxide (for example, yttrium oxide, tin oxide, or the like), carbon nanotubes, and an ion conducting substance (for example, potassium titanate, LiCl, or the like), and among these, for example, carbon black is preferable.

Each of these conductive agents may be used alone, or two or more of these conductive agents may be used in combination.

Examples of the carbon black include Ketjen black, oil furnace black, channel black (that is, gas black), and acetylene black. As the carbon black, carbon black subjected to a surface treatment (hereinafter, also referred to as “surface-treated carbon black”) may be used.

The surface-treated carbon black is obtained by adding, for example, a carboxy group, a quinone group, a lactone group, a hydroxy group, or the like to the surface of the carbon black. Examples of the surface treatment method include an air oxidation method of reacting the carbon black by bringing the carbon black into contact with air in a high temperature atmosphere, a method of reacting the carbon black with nitrogen oxide or ozone at room temperature (for example, 22° C.), and a method of oxidizing the carbon black with air in a high temperature atmosphere and then with ozone at a low temperature.

Among these, for example, the conductive agent may be channel black, and particularly, may be acidic carbon black having a pH of 5.0 or less.

Examples of the acidic carbon black include carbon black in which a surface is oxidatively treated, such as carbon black obtained by imparting a carboxyl group, a quinone group, a lactone group, a hydroxyl group, or the like to the surface.

From the viewpoint of improving transferability to embossed paper, the acidic carbon black is, for example, preferably carbon black having a pH of 4.5 or less, more preferably acidic carbon black having a pH of 4.0 or less, still more preferably acidic carbon black having a pH of 3.0 or less, particularly preferably acidic carbon black having a pH of 2.0 or more and 3.0 or less, and extremely preferably acidic carbon black having a pH of 2.0 or more and 2.8 or less.

The pH of the acidic carbon black is a value measured by a pH measuring method specified in JIS Z8802 (2011).

A content of the conductive agent with respect to the surface layer is, for example, preferably 5% by mass or more and 30% by mass or less, more preferably 10% by mass or more and 30% by mass or less, and still more preferably 15% by mass or more and 30% by mass or less.

### Other Additives

As the other additives, well-known additives such as a reinforcing agent, an antioxidant, a surfactant, and a heat aging inhibitor can be appropriately selected depending on the various uses of the electrophotographic member.

A content of the other additives with respect to the surface layer is, for example, preferably 30% by mass or less, more preferably 20% by mass or less, and still more preferably 10% by mass or less.

### Thickness of Surface Layer

A thickness of the surface layer is, for example, preferably 5 μm or more and 30 μm or less, more preferably 8 μm or more and 25 μm or less, and still more preferably 10 μm or more and 20 μm or less.

In a case where the thickness of the surface layer is 5 μm or more, the influence of the roughness of the lower layer is likely to be received, and thus the decrease in adhesiveness characteristic is suppressed. As a result, the adhesiveness characteristic is likely to be improved.

In a case where the thickness of the surface layer is 30 μm or less, the decrease in bending resistance of the surface layer is suppressed.

The thickness of the surface layer is measured by observing a cross section of the surface layer using an optical microscope.

Specifically, a cross section of the surface layer, cut along the thickness direction of the surface layer, is observed. In the cross section observation, thicknesses of the surface layer at three locations are measured and arithmetically averaged.

### Method of Forming Surface Layer

Examples of a method of forming the surface layer include a method of forming the surface layer by a coating method such as a blade coating method, a dip coating method, a spray coating method, a ring coating method, and a brush coating method.

The surface layer is formed by applying a coating liquid containing the above-described components and a solvent as necessary onto a substrate by the above-described coating method, and drying or drying and curing the coating liquid.

Here, the substrate corresponds to, for example, a monolayer of a resin layer, a monolayer of an elastic layer, a laminate including a resin layer and an elastic layer, and the like.

In the method of forming the surface layer, as the coating method, for example, a blade coating method, a dip coating method, a spray coating method, or a ring coating method is preferable.

Here, in the blade coating method, a spiral streak (also referred to as “spiral trace”) is generated by spreading the coating liquid with a metal plate (that is, a blade). In the dip coating method or the ring coating method, a film thickness difference in an axial direction occurs due to liquid dripping. In the spray coating method, a surface roughness in a pear skin shape occurs due to coating unevenness. In this way, the surface layer is likely to have coating defects.

However, in a case where the coating liquid containing the above-described components and a solvent as necessary is used and these coating methods are applied, a surface layer having reduced coating defects can be formed.

In a case where the blade coating method is applied, the surface layer is formed as follows, for example.

(1) The substrate is fixed to an outer peripheral surface of a cylindrical mold having a width longer than the substrate.

(2) A coating device that discharges the coating liquid is moved relative to the cylindrical mold along an axial direction of the mold at a target coating speed in a state in which the axial direction of the mold is along the horizontal direction while rotating the cylindrical mold in a circumferential direction, and the coating liquid is continuously applied onto the substrate.

(3) A metal plate (that is, a blade) having a width shorter than the base material is moved along the axial direction at the same speed as the coating speed of the coating device in a state of being brought into contact with the coating liquid applied onto the base material to spread the coating liquid.

(4) The spread coating film of the coating liquid is dried or dried and cured to form the surface layer.

In a case where the dip coating method is applied, the surface layer is formed as follows, for example.

(1) The substrate is fixed to an outer peripheral surface of a cylindrical mold having a width longer than the substrate.

(2) The coating liquid is filled in a cylindrical container having a bottom, and the substrate fixed to the cylindrical mold is dipped in the coating liquid.

(3) The dipped base material is pulled up to apply the coating liquid onto the base material.

(4) The coating film of the coating liquid is dried or dried and cured to form the surface layer.

In a case where the spray coating method is applied, the surface layer is formed as follows, for example.

(1) The substrate is fixed to an outer peripheral surface of a cylindrical mold having a width longer than the substrate.

(2) A coating device that sprays the coating liquid is moved relative to the cylindrical mold along an axial direction of the mold at a target coating speed in a state in which the axial direction of the mold is along the horizontal direction while rotating the cylindrical mold in a circumferential direction, and the coating liquid is applied onto the substrate.

(3) The coating liquid is applied in a plurality of layers by repeating reciprocating movement of the coating device in the axial direction of the mold while spraying the coating liquid from the coating device to obtain a coating film.

(4) The coating film of the coating liquid is dried or dried and cured to form the surface layer.

In a case where the ring coating method is applied, the surface layer is formed as follows, for example.

(1) The substrate is fixed to an outer peripheral surface of a cylindrical mold having a width longer than the substrate.

(2) The substrate fixed to the cylindrical mold is inserted into a substrate insertion portion of a ring-shaped coating device until the substrate is exposed from the substrate insertion portion in a state in which an axial direction of the mold is along the vertical direction and the substrate is coaxial with the substrate insertion portion; the coating liquid is discharged from a side surface of the substrate insertion portion of the ring-shaped coating device while moving the ring-shaped coating device and the substrate relative to each other in the substrate axial direction to apply the coating liquid onto the substrate;
here, as the ring-shaped coating device, for example, a coating device in which a resin sheet having a hole is fixed to a bottom surface of a cylindrical metal container having a hole in the bottom surface, the resin sheet being coaxial with the hole of the cylindrical metal container, with a gap is applied; the bottom surface of the cylindrical metal container and the hole of the resin sheet are the substrate insertion portion; the coating liquid is poured between the bottom surface of the ring-shaped coating device and the resin sheet to discharge the coating liquid from the side surface of the base material insertion portion.

(3) The coating film of the coating liquid is dried or dried and cured to form the surface layer.

In a case where the brush coating method is applied, the surface layer is formed as follows, for example.

(1) The substrate is fixed to an outer peripheral surface of a cylindrical mold having a width longer than the substrate.

(2) A brush having a width larger than the substrate and impregnated with the coating liquid is brought into contact with the substrate while moving the brush relative to the mold along an axial direction of the mold at a target coating speed in a state in which the axial direction of the mold is along a horizontal direction while rotating the cylindrical mold in a circumferential direction, and the coating liquid is applied onto the substrate.

(3) The coating liquid is applied in a plurality of layers by repeating reciprocating movement of the brush in the axial direction of the mold to obtain a coating film.

(4) The coating film of the coating liquid is dried or dried and cured to form the surface layer.

### Elastic Layer

The elastic layer contains an elastic material. The elastic layer may contain a conductive agent, other additives, and the like.

The elastic layer may be a layer that functions as an interlayer of the electrophotographic member or a layer that functions as a substrate layer.

The elastic layer refers to a layer that is deformed by an external force of 100 Pa but is restored to the original shape.

### Elastic Material

Examples of the elastic material include isoprene rubber, chloroprene rubber, epichlorohydrin rubber, butyl rubber, polyurethane rubber, silicone rubber, fluororubber, styrene-butadiene rubber, butadiene rubber, nitrile rubber, ethylene-propylene rubber, epichlorohydrin-ethylene oxide copolymer rubber, epichlorohydrin-ethylene oxide-allyl glycidyl ether copolymer rubber, ethylene-propylene-diene terpolymer rubber (EPDM), acrylonitrile-butadiene copolymer rubber (NBR), natural rubber, and blended rubber thereof. Among these, polyurethane, silicone rubber, EPDM, epichlorohydrin-ethylene oxide copolymer rubber, NBR, or a blend rubber thereof is used. These elastic materials may be foamed or unfoamed.

A content of the elastic material is an amount of the principal component of the elastic layer. Here, the amount of the principal component of the elastic layer means an amount of the component that is the highest among components contained in the elastic layer.

### Conductive Agent

Examples of the conductive agent contained in the elastic layer include the same examples as the conductive agents exemplified for the surface layer.

In a case of the conductive agent described above, a content of the conductive agent contained in the elastic layer is, for example, preferably in a range of 1% by mass or more and 50% by mass or less and more preferably in a range of 10% by mass or more and 30% by mass or less with respect to the elastic material.

### Other Additives

As the other additives contained in the elastic layer, well-known additives such as a reinforcing agent, an antioxidant, a surfactant, and a heat aging inhibitor can be appropriately selected depending on the various uses of the electrophotographic member.

A content of the other additives with respect to the elastic layer is, for example, preferably 30% by mass or less, more preferably 20% by mass or less, and still more preferably 10% by mass or less.

### Resin Layer

The resin layer contains a resin material. The resin layer may contain a conductive agent, other additives, and the like.

The resin layer may be a layer that functions as an interlayer of the electrophotographic member or a layer that functions as a substrate layer.

### Resin Material

Examples of the resin material include a polyimide resin (PI resin), a polyamide-imide resin (PAI resin), an aromatic polyether ketone resin (for example, an aromatic polyether ether ketone resin or the like), a polyphenylene sulfide resin (PPS resin), and a polyetherimide resin (PEI resin), a polyester resin, a polyamide resin, and a polycarbonate resin.

### Conductive Agent

Examples of the conductive agent contained in the resin layer include the same examples as the conductive agents exemplified for the surface layer.

In a case of the conductive agent described above, a content of the conductive agent contained in the resin layer is, for example, preferably in a range of 1% by mass or more and 50% by mass or less and more preferably in a range of 10% by mass or more and 30% by mass or less with respect to the elastic material.

### Other Additives

As the other additives contained in the resin layer, well-known additives such as a reinforcing agent, an antioxidant, a surfactant, and a heat aging inhibitor can be appropriately selected depending on the various uses of the electrophotographic member.

A content of the other additives with respect to the resin layer is, for example, preferably 30% by mass or less, more preferably 20% by mass or less, and still more preferably 10% by mass or less.

### Other Layers

The electrophotographic member according to the present exemplary embodiment may include a metal heat generation layer that is heated by electromagnetic induction and a metal substrate that functions as a substrate, in addition to the surface layer, the elastic layer, and the resin layer.

### Transfer Device

The transfer device according to the present exemplary embodiment includes the electrophotographic member according to the present exemplary embodiment described above, as a transfer member.

The transfer device according to the present exemplary embodiment includes, for example, an intermediate transfer body to which a toner image is transferred onto a surface, a primary transfer device including a primary transfer member that performs primary transfer of the toner image onto the surface of the intermediate transfer body, and a secondary transfer device including a secondary transfer member that performs secondary transfer of the toner image transferred onto the surface of the intermediate transfer body to a surface of a recording medium.

In the transfer device according to the present exemplary embodiment, the electrophotographic member according to the present exemplary embodiment described above is applied to any of the intermediate transfer body, the primary transfer member, or the secondary transfer member.

### Primary Transfer Device

In the primary transfer device, the primary transfer member is disposed to face the image holder across the intermediate transfer belt. In the primary transfer device, a voltage with polarity opposite to charging polarity of a toner is applied to the intermediate transfer belt by the primary transfer member, whereby a toner image is primarily transferred to the outer peripheral surface of the intermediate transfer body.

### Secondary Transfer Device

In the secondary transfer device, the secondary transfer member is disposed on a toner image-holding side of the intermediate transfer body. The secondary transfer device includes, for example, a secondary transfer member and a back surface member that is disposed on the side opposite to the toner image-holding side of the intermediate transfer body. In the secondary transfer device, the intermediate transfer body and the recording medium are interposed between the secondary transfer member and the back surface member, and a transfer electric field is formed. In this way, secondary transfer of the toner image formed on the intermediate transfer body to the recording medium is performed.

The secondary transfer member may be a secondary transfer roll or a secondary transfer belt. As the back surface member, for example, a back roll is used.

The transfer device according to the present exemplary embodiment may be a transfer device that transfers a toner image to the surface of a recording medium via a plurality of intermediate transfer bodies. That is, the transfer device may be, for example, a transfer device in which a toner image is primarily transferred to a first intermediate transfer body from an image holder, the toner image is secondarily transferred to a second intermediate transfer body from the first intermediate transfer body, and then the toner image is tertiarily transferred to a recording medium from the second intermediate transfer body.

### Image Forming Apparatus

The image forming apparatus according to the present exemplary embodiment includes:
an image holder;
a charging device that charges a surface of the image holder;
an electrostatic latent image forming device that forms an electrostatic latent image on the charged surface of the image holder;
a developing device that accommodates a developer containing a toner and develops the electrostatic latent image formed on the surface of the image holder with the developer to form a toner image;
a transfer device that transfers the toner image onto a surface of a recording medium; and
the fixing device that fixes the toner image on the surface of the recording medium.

As the transfer device, the transfer device according to the present exemplary embodiment described above is used.

In the image forming apparatus according to the present exemplary embodiment, the transfer device may be made into each cartridge such that the fixing device is detachable from an image forming apparatus. That is, the image forming apparatus according to the present exemplary embodiment may include the transfer device according to the present exemplary embodiment, as a device configuring a process cartridge.

Hereinafter, the image forming apparatus according to the present exemplary embodiment will be described with reference to a drawing.

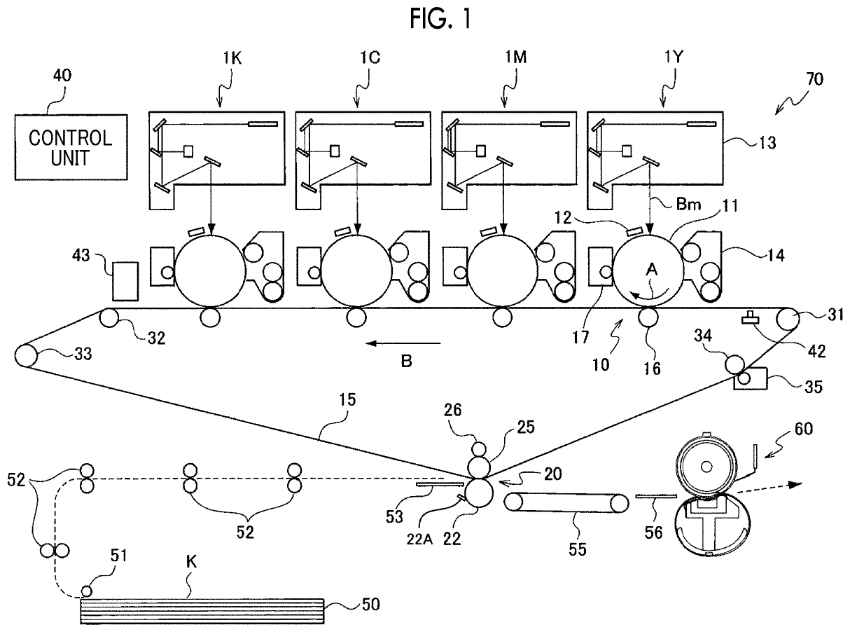

FIG. 1 is a schematic configuration view showing a configuration of the image forming apparatus according to the present exemplary embodiment.

As shown in FIG. 1, an image forming apparatus 100 according to the present exemplary embodiment is, for example, an intermediate transfer-type image forming apparatus generally called a tandem type.

The image forming apparatus 100 includes a plurality of image forming units 1Y, 1M, 1C, and 1K, an intermediate transfer belt 15, a primary transfer unit 10, a secondary transfer unit 20, and the fixing device 60. In addition, the image forming apparatus 100 includes a control unit 40 that controls the operation of each device (or each unit).

Here, the image forming units 1Y, 1M, 1C, and 1K are image forming units that form a toner image of each color component by an electrophotographic method.

The primary transfer unit 10 is a transfer unit that sequentially transfers (primary transfers) the toner image of each color component formed by the image forming units 1Y, 1M, 1C, and 1K to the intermediate transfer belt 15.

The secondary transfer unit 20 is a transfer unit that collectively transfers (secondary transfers) the superimposed toner images transferred to the intermediate transfer belt 15 to the paper K that is the recording medium.

The fixing device 60 is a device that fixes the image transferred by the secondary transfer to the paper K.

Each of the image forming units 1Y, 1M, 1C, and 1K of the image forming apparatus 100 includes a photoreceptor 11 that rotates in a direction of an arrow A, as an example of an image holder that holds a toner image formed on the surface.

Around the photoreceptor 11, a charger 12 that charges the photoreceptor 11 is provided as an example of the charging device. Around the photoreceptor 11, a laser exposure device 13 (exposure beam is indicated by a reference numeral Bm in the drawing) that writes an electrostatic latent image on the photoreceptor 11 is provided as an example of the electrostatic latent image forming device.

Around the photoreceptor 11, a developer 14 that accommodates the toner of each color component and visualizes the electrostatic latent image on the photoreceptor 11 with the toner is provided as an example of the developing device.

Around the photoreceptor 11, a primary transfer roll 16 that transfers the toner image of each color component formed on the photoreceptor 11 to the intermediate transfer belt 15 by the primary transfer unit 10 is provided.

Around the photoreceptor 11, a photoreceptor cleaner 17 that removes a residual toner on the photoreceptor 11 is provided.

The charger 12, the laser exposure device 13, the developer 14, the primary transfer roll 16, and the photoreceptor cleaner 17 are sequentially arranged around the photoreceptor 11 along the rotation direction of the photoreceptor 11.

These image forming units 1Y, 1M, 1C, and 1K are substantially linearly arranged in order of yellow (Y), magenta (M), cyan (C), and black (K) from the upstream side of the intermediate transfer belt 15.

By various rolls, the intermediate transfer belt 15 is driven to circulate (rotate) in the direction of an arrow B shown in FIG. 1 at a speed fit for the purpose.

The various rolls include a drive roll 31, a support roll 32, a tension applying roll 33, a back roll 25, and a cleaning back roll 34.

The drive roll 31 is a roll that is driven by a motor (not shown) having an excellent constant speed property and rotates the intermediate transfer belt 15.

The support roll 32 is a roll that supports the intermediate transfer belt 15 extending in a substantially linear shape along the arrangement direction of each photoreceptor 11.

The tension applying roll 33 is a roll that is provided in the secondary transfer unit 20, has a function of applying a tension to the intermediate transfer belt 15, and prevents the intermediate transfer belt 15 from meandering.

The cleaning back roll 34 is a roll that is provided in a cleaning portion that scrapes off the residual toner on the intermediate transfer belt 15.

The primary transfer unit 10 is configured with the primary transfer roll 16 that is disposed to face the photoreceptor 11 across the intermediate transfer belt 15.

The primary transfer roll 16 is disposed to be pressed against the photoreceptor 11 with the intermediate transfer belt 15 therebetween, and a voltage with a polarity (primary transfer bias) opposite to the charging polarity (negative polarity; the same applies hereafter) of the toner is applied to the primary transfer roll 16. As a result, the toner image on each photoreceptor 11 is sequentially electrostatically sucked onto the intermediate transfer belt 15, which leads to the formation of overlapped toner images on the intermediate transfer belt 15.

The secondary transfer unit 20 is configured to include the back roll 25 and a secondary transfer roll 22 that is disposed on a toner image-holding surface side of the intermediate transfer belt 15.

The secondary transfer roll 22 is disposed to be pressed on the back roll 25 across the intermediate transfer belt 15, and the secondary transfer roll 22 is grounded such that the secondary transfer bias is formed between the secondary transfer roll 22 and the back roll 25, that induces secondary transfer of the toner image onto the paper K transported to the secondary transfer unit 20.

In addition, an intermediate transfer belt cleaner 35 is provided on the downstream side of the secondary transfer unit 20 on the intermediate transfer belt 15 to be freely attachable to and detachable from the intermediate transfer belt 15.

The intermediate transfer belt cleaner 35 is a cleaner that removes the residual toner or paper powder on the intermediate transfer belt 15 after the secondary transfer, and cleans the surface of the intermediate transfer belt 15.

The intermediate transfer belt 15, the primary transfer unit 10 (primary transfer roll 16), and the secondary transfer unit 20 (secondary transfer roll 22) correspond to an example of the transfer device.

The image forming apparatus 100 may have a configuration in which the apparatus includes a secondary transfer belt instead of the secondary transfer roll 22.

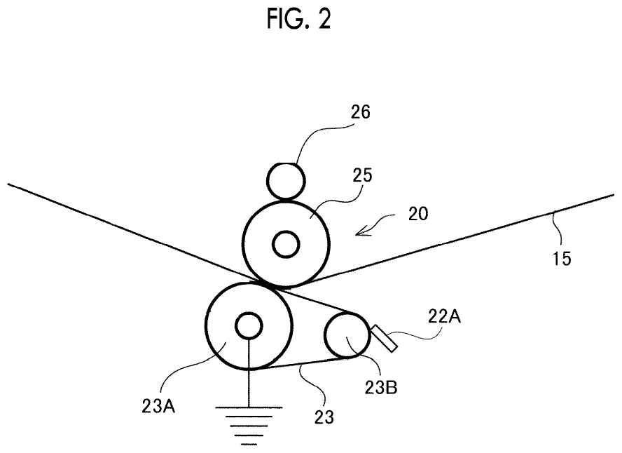

Specifically, as shown in FIG. 2, the image forming apparatus 100 may include a secondary transfer device including a secondary transfer belt 23, a drive roll 23A, and an idle roll 23B.

The drive roll 23A is a roll that is disposed to face the back roll 25 through the intermediate transfer belt 15 and the secondary transfer belt 23.

The idle roll 23B is a roll that tensions the secondary transfer belt 23 together with the drive roll 23A.

On the other hand, a reference sensor (home position sensor) 42 is disposed on an upstream side of the yellow image forming unit 1Y.

The reference sensor 42 is a sensor that generates a reference signal serving as a reference for taking an image forming timing in each of the image forming units 1Y, 1M, 1C, and 1K.

The reference sensor 42 recognizes a mark provided on a back side of the intermediate transfer belt 15 to generate the reference signal. Each of the image forming units 1Y, 1M, 1C, and 1K is configured to start the image formation in response to an instruction from the control unit 40 based on the recognition of the reference signal.

An image density sensor 43 used to adjust image quality is provided on the downstream side of the black image forming unit 1K.

The image forming apparatus 100 includes a paper storage portion 50, a paper feeding roll 51, a transport roll 52, a transport guide 53, a transport belt 55, and a fixing inlet guide 56.

The paper storage portion 50 is a storage unit that accommodates the paper K, as a transport device that transports the paper K.

The paper feeding roll 51 is a roll that takes out the paper K accumulated in the paper storage portion 50 at a predetermined timing, and transports the paper K.

The transport roll 52 is a roll that transports the paper K fed by the paper feeding roll 51.

The transport guide 53 is a guide that feeds the paper K transported by the transport roll 52 to the secondary transfer unit 20.

The transport belt 55 is a belt that transports the paper K, that is secondarily transferred by the secondary transfer roll 22, to the fixing device 60.

The fixing inlet guide 56 is a guide that guides the paper K to the fixing device 60.

Next, basic image forming process of the image forming apparatus 100 according to the present exemplary embodiment will be described.

In the image forming apparatus 100 according to the present exemplary embodiment, image data output from an image reading device (not shown), a personal computer (PC) (not shown), or the like is subjected to image processing by an image processing device (not shown), and then the image forming units 1Y, 1M, 1C, and 1K perform the image forming operation.

In the image processing device, various types of image processing, such as shading correction, misregistration correction, brightness/color space conversion, gamma correction, frame removal or color editing, and movement editing, are performed on input image data. The image data that has been subjected to the image processing is converted into color material gradation data of four colors of yellow (Y), magenta (M), cyan (C), and black (K), and is output to the laser exposure device 13.

In the laser exposure device 13, according to the input color material gradation data, for example, the photoreceptor 11 of each of the image forming units 1Y, 1M, 1C, and 1K is irradiated with an exposure beam Bm emitted from a semiconductor laser. The surface of each of the photoreceptors 11 of the image forming units 1Y, 1M, 1C, and 1K is charged by the charger 12, and is then scanned and exposed by the laser exposure device 13, so that the electrostatic latent image is formed. By each of the image forming units 1Y, 1M, 1C, and 1K, the formed electrostatic latent image is developed as a toner image of each of the colors of yellow (Y), magenta (M), cyan (C), and black (K).

The toner image formed on each of the photoreceptors 11 of the image forming units 1Y, 1M, 1C, and 1K is transferred onto the intermediate transfer belt 15 at the primary transfer unit 10 where each photoreceptor 11 and the intermediate transfer belt 15 are in contact with each other. More specifically, in the primary transfer unit 10, by the primary transfer roll 16, a voltage (primary transfer bias) with a polarity opposite to the charging polarity (negative polarity) of the toner is applied to the base material of the intermediate transfer belt 15, and the toner images are sequentially overlapped on the surface of the intermediate transfer belt 15 and subjected to primary transfer.

After the primary transfer by which the toner images are sequentially transferred to the surface of the intermediate transfer belt 15, the intermediate transfer belt 15 moves, and the toner images are transported to the secondary transfer unit 20. In a case where the toner images are transported to the secondary transfer unit 20, in the transport device, the paper feeding roll 51 rotates in accordance with the timing at which the toner images are transported to the secondary transfer unit 20, and the paper K having the target size is fed from the paper storage portion 50. The paper K fed from the paper feeding roll 51 is transported by the transport roll 52, passes through the transport guide 53, and reaches the secondary transfer unit 20. The paper K is temporarily stopped before reaching the secondary transfer unit 20. The position alignment roll (not shown) rotates in accordance with the movement timing of the intermediate transfer belt 15 on which the toner image is held, and the position of the paper K and the position of the toner image are aligned.

In the secondary transfer unit 20, via the intermediate transfer belt 15, the secondary transfer roll 22 is pressed on the back roll 25. At this time, the paper K transported at the right timing is interposed between the intermediate transfer belt 15 and the secondary transfer roll 22. At this time, in a case where a voltage (secondary transfer bias) with the same polarity as the charging polarity (negative polarity) of the toner is applied from the power supply roll 26, a transfer electric field is formed between the secondary transfer roll 22 and the back roll 25. In the secondary transfer unit 20 pressed by the secondary transfer roll 22 and the back roll 25, the unfixed toner images held on the intermediate transfer belt 15 are electrostatically transferred onto the paper K in a batch.

Thereafter, the paper K on which the toner image is electrostatically transferred is transported as it is in a state of being peeled off from the intermediate transfer belt 15 by the secondary transfer roll 22. The paper K is transported to the transport belt 55 provided on a downstream side of the secondary transfer roll 22 in the paper transport direction. The transport belt 55 transports the paper K to the fixing device 60 according to the optimum transport speed in the fixing device 60. The unfixed toner images on the paper K transported to the fixing device 60 are fixed on the paper K by being subjected to a fixing treatment by heat and pressure by the fixing device 60. The paper K on which the fixed image is formed is transported to an ejected paper-storing portion (not shown) provided in an output portion of the image forming apparatus 100.

On the other hand, after the transfer to the paper K is completed, the residual toner remaining on the intermediate transfer belt 15 is transported to the cleaning unit with the rotation of the intermediate transfer belt 15. The residual toner is removed from the intermediate transfer belt 15 by the cleaning back roll 34 and the intermediate transfer belt cleaner 35.

Although the present exemplary embodiment has been described, the present exemplary embodiment is not limited to the above-described exemplary embodiments, and various modifications, changes, and ameliorations can be added thereto.

### EXAMPLES

Hereinafter, the present exemplary embodiment will be described in more detail with reference to Examples, but the present exemplary embodiment is not limited to Examples. In the following description, “part” represents “part by mass” unless otherwise specified.

### Example 1

### Production of Elastic Layer

A rubber composition is prepared by formulating the following components at the following proportions.
Chloroprene rubber (CR) “TSR-61” (manufactured by Tosoh Corporation): 35 parts
Epichlorohydrin rubber (ECO) “610” (manufactured by Daiso Co., Ltd.): 15 parts
Ethylene propylene diene rubber (EPDM) “EP33” (manufactured by JSR Corporation): 35 parts
Nitrile butadiene rubber (NBR) “DN211” (manufactured by Zeon Corporation): 15 parts
Sulfur (manufactured by Tsurumi Chemical Industry Co., Ltd.): 0.5 parts
Zinc oxide (manufactured by Kyodo Chemical Co., Ltd.): 5 parts
Vulcanizing accelerator “Noxeller M” (manufactured by Ouchi Shinko Chemical Industry Co., Ltd.): 1 part
Stearic acid: 0.5 parts
Conductivity imparting agent (carbon black) “#3030B” (manufactured by Mitsubishi Chemical Corporation): 23 parts

Next, the rubber composition is put into a Banbury mixer and kneaded, and then further kneaded with two rolls. The obtained kneaded product is molded into an endless belt shape by an extrusion molding machine equipped with a tube crosshead.

Next, the rubber composition molded into an endless belt shape is heated in a vulcanizer with pressurized steam (temperature: 126° C., pressure: 1.5 kg/cm²) to form an elastic layer. The elastic layer is covered on the outer side of the metal-made tube (conductive substrate), and the surface is polished to obtain an endless belt-like elastic layer (diameter: 40 mm, width: 340 mm, thickness: 492 μm).

### Production of Surface Layer

34 parts by mass (an amount of 6% by volume with respect to the surface layer) of SQ1 (PSS-octakis (dimethylsilyloxy) substituted substance, manufactured by Sigma-Aldrich Co., LLC, R¹ of T unit=a dimethylsilyloxy group, volume average particle diameter=5.0 μm) as polysiloxane compound particles and 15 parts by mass of carbon black “FW200” (manufactured by Degussa-Hüls AG) as a conductive agent are added to 100 parts by mass of silicone-modified acrylic urethane (manufactured by Henkel Japan Ltd.) as a binding material to prepare a coating liquid for forming a surface layer.

Next, the coating liquid for forming a surface layer is spray-coated on a surface of the manufactured elastic layer, and heated and dried at 120° C. for 20 minutes to form a surface layer (thickness: 8 μm). An electrophotographic member having a diameter of 40 mm, a width of 340 mm, and a thickness of 500 μm is obtained.

### Examples 2 to 15 and Comparative Example 1

An electrophotographic member is obtained in the same manner as in Example 1, except that the kind and amount of the polysiloxane compound particles and the thickness of the surface layer are changed.

### Example 16

### Production of Resin Layer

A coating liquid of a resin layer is prepared by formulating the following components at the following proportions.
Polyamic acid NMP solution (concentration of solid contents: 45% by mass) 100 parts by mass
Acidic carbon black (dry state; conductive carbon particles) [SPECIAL BLACK 4: manufactured by Orion Engineered Carbons, pH: 4.5, volatile content: 18.0%, gas black (that is, channel black), number average primary particle diameter: 25 nm] 26 parts by mass

Next, the coating liquid is applied onto an outer peripheral surface of a cylindrical mold by a rotation coating method to form a coating film. Thereafter, a drying treatment is performed on the coating film in a drying furnace at 140° C. in an air atmosphere while rotating the coating film at 10 rpm for 15 minutes.

Next, the coating film is placed in an oven at a reaching temperature of 320° C. for 4 hours to obtain an endless belt-shaped resin layer (§ 366 mm, width: 369 mm). A film thickness of the resin layer is 80 μm.

A surface layer having a thickness of 5 μm is formed on the surface of the endless belt-shaped resin layer in the same manner as in Example 3 to obtain an electrophotographic member.

However, the amount of the polysiloxane compound particles in the surface layer is 5% by volume.

### Example 17

### Formation of Elastic Layer

As an elastic foaming body, EP70 (manufactured by INOAC Corporation) is used, and the elastic foaming body is polished and molded into a cylindrical shape having an outer diameter of 28 mm, an inner diameter of 15 mm, and a length of 350 mm to obtain a cylindrical elastic foaming body.

The elastic foaming body is dipped in a conductive treatment liquid obtained by mixing, in a mass ratio of 1:1, a water dispersion body containing and dispersing 36% by mass of carbon black and an acrylic emulsion (manufactured by Zeon Corporation, product name “Nipol LX852”) at 20° C. for 10 minutes as a conductive treatment liquid. The elastic foaming body obtained by the above-described method is dipped at 20° C. for 10 minutes.

Thereafter, the elastic foaming body to which the treatment liquid has adhered is heated and dried for 60 minutes in a curing furnace set to 100° C., such that water is removed and the acrylic resin is crosslinked. On an exposed surface of the elastic foaming body, a conductive coating layer containing carbon black is formed of the acrylic resin cured by crosslinking.

In this way, an elastic layer configured with an elastic foaming body and a conductive coating layer that coats an exposed surface of the elastic foaming body is obtained.

Next, a roll member is formed by inserting a conductive support member (made of SUS, diameter of 15 mm) having a surface to which an adhesive is applied, to the obtained elastic layer.

In addition, a hysteresis loss of the elastic foaming body is 27%.

### Formation of Resin Layer

70 parts of an urethane oligomer (manufactured by Nippon Synthetic Chemical Co., Ltd., Urethane acrylate UV3700B), 30 parts of an urethane monomer (manufactured by Kyoeisha Chemical Co., Ltd., isomyristyl acrylate), 0.5 parts of a polymerization initiator (manufactured by Ciba Specialty Chemicals, 1-hydroxycyclohexylphenyl ketone Irgacure 184), and 3 parts of alkyltrimethylammonium percolate (product name “LXN-30” manufactured by Daiso Co., Ltd.) are mixed to obtain a coating liquid for forming an interlayer. The obtained coating liquid for forming an interlayer is applied onto the elastic layer of the roll member using a die coater. While the roll member is rotated, the coating film is irradiated with UV rays at an UV irradiation intensity of 700 mW/cm² for 5 seconds. In the operation, an interlayer having a thickness of 1 mm consisting of a urethane resin layer is formed.

### Formation of Surface Layer

A surface layer is formed on the surface of the interlayer in the same manner as in Example 4 to obtain an electrophotographic member.

However, the amount of the polysiloxane compound particles in the surface layer is 5% by volume.

### Evaluation of Characteristics

The following characteristics of the electrophotographic member of each of Examples are measured by the above-described method.
Adhesiveness characteristic of surface layer: indicates a blowing pressure of air in a case where all the polyester resin particles attached to the surface of the surface layer are separated from the surface of the surface layer.

### Evaluation of Paper Contamination (Contamination of Back Surface of Paper)

The electrophotographic member of each example is mounted on an evaluation image forming apparatus (modified machine of “DocuColor-7171P” manufactured by FUJIFILM Business Innovation Corp.) as a secondary transfer belt of the transfer device.

However, in Example 17, a modified machine of an evaluation image forming apparatus, that includes a transfer device including a secondary transfer roll, is applied. The electrophotographic member of Example 17 is mounted on the evaluation image forming apparatus as a secondary transfer roll of the transfer device.

The following evaluations are performed by the evaluation image forming apparatus.

1000 A4-size paper sheets are output from the evaluation image forming apparatus, each having a 50% magenta halftone image. Contamination of the paper is evaluated according to the following standard.

A+: proportion of paper on which paper contamination is confirmed is less than 3%.

A: proportion of paper on which paper contamination is confirmed is 3% or more and less than 5%.

B: proportion of paper on which paper contamination is confirmed is 5% or more and less than 10%.

C: proportion of paper on which paper contamination is confirmed is 10% or more and less than 15%.

D: proportion of paper on which paper contamination is confirmed is 20% or more.

### Bending Resistance of Surface Layer

Bending resistance of the surface layer in the electrophotographic member of each example is evaluated as follows.

Test pieces having a length of 100 mm and a width of 15 mm are cut out from each roll, and the number of times of bending is measured under conditions of a bending speed of 175 times/min, a rotation angle of 135 degrees, and a tensile load of 14.7 N (1.5 kgf) using a MIT bending fatigue tester manufactured by TOYO SEIKI co., LTD. The evaluation standards are as follows.

A: no crack is generated in the bending portion.

B: crack is generated in a part of the bending portion.

C: crack is generated on half of the bending portion.

D: crack is generated on the entire surface of the bending portion.

### Used Materials

Details of the materials used in each example are as follows.
SQ1: PSS-octakis (dimethylsilyloxy) substituted substance, manufactured by Sigma-Aldrich Co., LLC, R¹ of T unit=a dimethylsilyloxy group, volume average particle diameter=5.0 μm
SQ2: X-52-854, manufactured by Shin-Etsu Chemical Co., Ltd., volume average particle diameter=0.7 μm
SQ3: KMP-706, manufactured by Shin-Etsu Chemical Co., Ltd., volume average particle diameter=2.0 μm
SQ4: X-52-1621, manufactured by Shin-Etsu Chemical Co., Ltd., volume average particle diameter=5.0 μm

TABLE 1

| | Lower | Surface layer | | | | | | | |
|---|---|---|---|---|---|---|---|---|---|
| | layer | | Polysiloxane compound particles | | | | Characteristic | | |
| | of | Binding | | Particle | Amount | | Adhesiveness | Evaluation | |
| | surface | material | | diameter | % by | Thickness | characteristic | Paper | Bending |
| | layer | Type | Type | μm | volume | μm | kpa | contamination | resistance |
| Examples 1 | Elastic | Urethane | SQ1 | 5.0 | 6 | 20 | 1.0 | A+ | A |
| | layer | | | | | | | | |
| Examples 2 | Elastic | Urethane | SQ1 | 5.0 | 3 | 20 | 5.7 | A | A |
| | layer | | | | | | | | |
| Examples 3 | Elastic | Urethane | SQ2 | 0.7 | 4 | 15 | 1.5 | A | A |
| | layer | | | | | | | | |
| Examples 4 | Elastic | Urethane | SQ3 | 2.0 | 4 | 15 | 2.0 | B | A |
| | layer | | | | | | | | |
| Examples 5 | Elastic | Urethane | SQ4 | 5.0 | 4 | 15 | 2.5 | C | A |
| | layer | | | | | | | | |
| Examples 6 | Elastic | Urethane | SQ1 | 5.0 | 2 | 13 | 5.5 | C | A |
| | layer | | | | | | | | |
| Examples 7 | Elastic | Urethane | SQ1 | 5.0 | 3 | 13 | 5.0 | B | A |
| | layer | | | | | | | | |
| Examples 8 | Elastic | Urethane | SQ1 | 5.0 | 6 | 13 | 2.5 | A | A |
| | layer | | | | | | | | |
| Examples 9 | Elastic | Urethane | SQ1 | 5.0 | 40 | 13 | 1.5 | A | A |
| | layer | | | | | | | | |
| Examples 10 | Elastic | Urethane | SQ1 | 5.0 | 50 | 13 | 1 | A+ | B |
| | layer | | | | | | | | |
| Examples 11 | Elastic | Urethane | SQ1 | 5.0 | 55 | 13 | 0.8 | A+ | C |
| | layer | | | | | | | | |
| Examples 12 | Elastic | Urethane | SQ3 | 2.0 | 5 | 3 | 5.8 | C | A |
| | layer | | | | | | | | |
| Examples 13 | Elastic | Urethane | SQ3 | 2.0 | 5 | 5 | 4.8 | B | A |
| | layer | | | | | | | | |
| Examples 14 | Elastic | Urethane | SQ3 | 2.0 | 5 | 30 | 2.2 | A | B |
| | layer | | | | | | | | |
| Examples 15 | Elastic | Urethane | SQ3 | 2.0 | 5 | 40 | 1.3 | A+ | C |
| | layer | | | | | | | | |
| Examples 16 | Resin | Urethane | SQ2 | 0.7 | 5 | 5 | 2.2 | A | A |
| | layer | | | | | | | | |
| Examples 17 | Resin | Urethane | SQ3 | 2.0 | 5 | 15 | 2.5 | A | A |
| | layer | | | | | | | | |
| Comparative | Elastic | Urethane | — | — | — | — | 10 | D | D |
| Example 1 | layer | | | | | | | | |

From the above results, it is found that, in the present example, the contamination of the back surface of the paper is suppressed as compared with Comparative Examples.

In addition, it is found that the present example also has high bending resistance of the surface layer.

### Examples 101 to 125 and Comparative Example 101

A coating film is formed by applying a coating liquid for forming a surface layer according to Table 2 by a coating method, and the coating film is dried and cured to form a surface layer. An electrophotographic member is obtained in the same manner as in the example to which the formulation of the coating liquid for forming the surface layer is applied, except for the above.

However, in Table 2, in the column of the coating method, examples in which the coating speed is set to 50 mm/min as the condition of the blade coating method are indicated as “A”, and examples in which the coating speed is set to 200 mm/min are indicated as “B”.

### Evaluation of Characteristics, Evaluation of Paper Contamination (Contamination of Back Surface of Paper), and Evaluation of Bending Resistance of Surface Layer

As a result of performing the evaluation of characteristics, the evaluation of paper contamination (contamination of back surface of paper), and the evaluation of the bending resistance of the surface layer of the electrophotographic member of each of Examples, the same evaluation results as the results of the examples to which the formulation of the coating liquid for forming a surface layer is applied are obtained.

### Coating Defects of Surface Layer

Coating defects of the surface layer of the electrophotographic member of each of Examples is evaluated as follows.

### Spiral Trace

A surface of the surface layer is visually observed and evaluated according to the following standard.

A+: spiral trace is not visible at all.

A: faint spiral trace is visible.

B: clear spiral trace is visible in a part.

C: clear spiral trace is visible in the entire part.

### Drip

A film thickness difference Δ of the surface layer at a position 40 mm inward in the axial direction from both end parts is measured and evaluated according to the following standard.

A+: film thickness difference Δ is 0 μm or more and 5 μm or less.

A: film thickness difference Δ is more than 5 μm and 10 μm or less.

B: film thickness difference Δ is more than 10 μm and 15 μm or less.

C: film thickness difference Δ is more than 15 μm.

### Surface Roughness

A surface of the surface layer is visually observed and evaluated according to the following standard.

A+: no roughness in the pear skin is visible.

A: faint roughness in the pear skin is visible.

B: clear roughness in the pear skin is visible in a part.

C: clear roughness in the pear skin is visible in the entire part.

### Coating Streaks

A surface of the surface layer is visually observed and evaluated according to the following standard.

A+: no coating streaks are visible.

A: faint coating streaks are visible.

B: clear coating streaks are visible in a part.

C: clear coating streaks are visible in the entire part.

TABLE 2

| | | | | Evaluation | | | |
|---|---|---|---|---|---|---|---|
| | Formulation of coating liquid | | | | | Surface | Coating |
| | for forming surface layer | Coating method | | Spiral trace | Drip | roughness | streaks |
| Examples 101 | Formulation same as in | Blade coating method | A | A+ | A+ | A+ | A+ |
| | Example 1 | | | | | | |
| Examples 102 | Formulation same as in | Blade coating method | A | A+ | A+ | A+ | A+ |
| | Example 2 | | | | | | |
| Examples 103 | Formulation same as in | Blade coating method | A | A+ | A+ | A+ | A+ |
| | Example 3 | | | | | | |
| Examples 104 | Formulation same as in | Blade coating method | A | A+ | A+ | A+ | A+ |
| | Example 4 | | | | | | |
| Examples 105 | Formulation same as in | Blade coating method | A | A+ | A+ | A+ | A+ |
| | Example 5 | | | | | | |
| Examples 106 | Formulation same as in | Blade coating method | A | A+ | A+ | A+ | A+ |
| | Example 6 | | | | | | |
| Examples 107 | Formulation same as in | Blade coating method | A | A+ | A+ | A+ | A+ |
| | Example 7 | | | | | | |
| Examples 108 | Formulation same as in | Blade coating method | A | A+ | A+ | A+ | A+ |
| | Example 8 | | | | | | |
| Examples 109 | Formulation same as in | Blade coating method | A | A+ | A | A | A+ |
| | Example 9 | | | | | | |
| Examples 110 | Formulation same as in | Blade coating method | A | A+ | A | A | A+ |
| | Example 10 | | | | | | |
| Examples 111 | Formulation same as in | Blade coating method | A | A+ | A | A | A+ |
| | Example 11 | | | | | | |
| Examples 112 | Formulation same as in | Blade coating method | A | A | A+ | A+ | A+ |
| | Example 12 | | | | | | |
| Examples 113 | Formulation same as in | Blade coating method | A | A | A+ | A+ | A+ |
| | Example 13 | | | | | | |
| Examples 114 | Formulation same as in | Blade coating method | A | A+ | A | A+ | A+ |
| | Example 14 | | | | | | |
| Examples 115 | Formulation same as in | Blade coating method | A | A+ | A | A+ | A+ |
| | Example 15 | | | | | | |
| Examples 116 | Formulation same as in | Blade coating method | A | A+ | A+ | A+ | A+ |
| | Example 16 | | | | | | |
| Examples 117 | Formulation same as in | Blade coating method | A | A+ | A+ | A | A+ |
| | Example 17 | | | | | | |
| Examples 118 | Formulation same as in | Blade coating method | B | B | A+ | A | A+ |
| | Example 1 | | | | | | |
| Examples 119 | Formulation same as in | Dip coating method | | A+ | A+ | A | A+ |
| | Example 1 | | | | | | |
| Examples 120 | Formulation same as in | | | A+ | B | A+ | A+ |
| | Example 6 | | | | | | |
| Examples 121 | Formulation same as in | Spray coating method | | A+ | A | A+ | A+ |
| | Example 1 | | | | | | |
| Examples 122 | Formulation same as in | | | A+ | A+ | B | A+ |
| | Example 11 | | | | | | |
| Examples 123 | Formulation same as in | Ring coating method | | A+ | A+ | A | A+ |
| | Example 1 | | | | | | |
| Examples 124 | Formulation same as in | | | A+ | B | A+ | A+ |
| | Example 6 | | | | | | |
| Comparative | Formulation same as in | Blade coating method | A | A | B | A+ | A+ |
| Example 1 | Comparative Example 1 | | | | | | |
| Examples 125 | Formulation same as in | Ring coating method | | A | B | B | C |
| | Example 1 | | | | | | |

From the above results, it is found that, in a case where the surface layer is formed by the blade coating method, the dip coating method, the spray coating method, or the ring coating method using the coating liquid having the formulation of the surface layer of the present example, a surface layer with reduced coating defects can be formed compared to Comparative Examples or a case in which the brush coating method is applied.

The present exemplary embodiments include the following aspects.

(((1)))

An electrophotographic member comprising:
a surface layer that contains no fluorine material,
wherein, in a case where air is blown onto a surface of the surface layer from an upper side of the surface of the surface layer while a blowing pressure is increased after polyester resin particles having a volume average particle diameter of 4.7 μm are attached to the surface of the surface layer, all of the polyester resin particles attached to the surface of the surface layer are separated from the surface of the surface layer at a blowing pressure of 6 kPa or less.
   (((2)))

The electrophotographic member according to (((1))),
wherein the electrophotographic member comprises the surface layer that contains a binding material and polysiloxane compound particles, and
the polysiloxane compound particles are polysiloxane compound particles having a T unit represented by a formula: [R¹SiO_{3/2}]ₘ (in the formula, R¹ represents an organic group, m represents an integer of 2 or more, and at least one R¹ among a plurality of R¹'s present in the T unit is a group including at least one of an alkyl group or an aryl group).
   (((3)))

The electrophotographic member according to (((2))),
wherein the group including at least one of an alkyl group or an aryl group is a group including an alkyl group.
   (((4)))

The electrophotographic member according to any one of (((1))) to (((3))), further comprising:
at least one of a resin layer or an elastic layer below the surface layer.
   (((5)))

The electrophotographic member according to (((2))),
wherein a volume average particle diameter of the polysiloxane compound particles is 3.0 μm or less.
   (((6)))

The electrophotographic member according to (((5))),
wherein the volume average particle diameter of the polysiloxane compound particles is 1.0 μm or less.
   (((7)))

The electrophotographic member according to (((2))), (((3))), (((5))) or (((6))),
wherein a content of the polysiloxane compound particles with respect to the surface layer is 3% by volume or more and 50% by volume or less.
   (((8)))

The electrophotographic member according to (((7))),
wherein the content of the polysiloxane compound particles with respect to the surface layer is 6% by volume or more and 40% by volume or less.
   (((9)))

The electrophotographic member according to any one of (((1))) to (((8))),
wherein a thickness of the surface layer is 5 μm or more and 30 μm or less.
   (((10)))

A transfer device comprising:
a transfer member configured of the electrophotographic member according to any one of (((1))) to (((9))).
   (((11)))

An image forming apparatus comprising:
an image holder;
a charging device that charges a surface of the image holder;
an electrostatic latent image forming device that forms an electrostatic latent image on the charged surface of the image holder;
a developing device that accommodates a developer containing a toner and develops the electrostatic latent image formed on the surface of the image holder with the developer to form a toner image;
the transfer device according to (((10))), that transfers the toner image onto a surface of a recording medium; and
a fixing device that fixes the toner image on the surface of the recording medium.
   (((12)))

A method of forming the surface layer of the electrophotographic member according to any one of (((1))) to (((9))), the method comprising:
forming the surface layer by a blade coating method.
   (((13)))

A method of forming the surface layer of the electrophotographic member according to any one of (((1))) to (((9))), the method comprising:
forming the surface layer by a dip coating method.
   (((14)))

A method of forming the surface layer of the electrophotographic member according to any one of (((1))) to (((9))), the method comprising:
forming the surface layer by a spray coating method.
   (((15)))

A method of forming the surface layer of the electrophotographic member according to any one of (((1)))) to (((9))), the method comprising:
forming the surface layer by a ring coating method.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrophotographic member comprising:
a surface layer that contains no fluorine material,
wherein, in a case where air is blown onto a surface of the surface layer from an upper side of the surface of the surface layer while a blowing pressure is increased after polyester resin particles having a volume average particle diameter of 4.7 μm are attached to the surface of the surface layer, all of the polyester resin particles attached to the surface of the surface layer are separated from the surface of the surface layer at a blowing pressure of 6 kPa or less.

2. The electrophotographic member according to claim 1,
wherein the electrophotographic member comprises the surface layer that contains a binding material and polysiloxane compound particles, and
the polysiloxane compound particles are polysiloxane compound particles having a T unit represented by a formula: [R¹SiO_{3/2}]ₘ (in the formula, R¹ represents an organic group, m represents an integer of 2 or more, and at least one R¹ among a plurality of R¹'s present in the T unit is a group including at least one of an alkyl group or an aryl group).

3. The electrophotographic member according to claim 2,
wherein the group including at least one of an alkyl group or an aryl group is a group including an alkyl group.

4. The electrophotographic member according to claim 1, further comprising:
at least one of a resin layer or an elastic layer below the surface layer.

5. The electrophotographic member according to claim 2,
wherein a volume average particle diameter of the polysiloxane compound particles is 3.0 μm or less.

6. The electrophotographic member according to claim 5,
wherein the volume average particle diameter of the polysiloxane compound particles is 1.0 μm or less.

7. The electrophotographic member according to claim 2,
wherein a content of the polysiloxane compound particles with respect to the surface layer is 3% by volume or more and 50% by volume or less.

8. The electrophotographic member according to claim 7,
wherein the content of the polysiloxane compound particles with respect to the surface layer is 6% by volume or more and 40% by volume or less.

9. The electrophotographic member according to claim 1,
wherein a thickness of the surface layer is 5 μm or more and 30 μm or less.

10. A transfer device comprising:
a transfer member configured of the electrophotographic member according to claim 1.

11. A transfer device comprising:
a transfer member configured of the electrophotographic member according to claim 2.

12. A transfer device comprising:
a transfer member configured of the electrophotographic member according to claim 3.

13. A transfer device comprising:
a transfer member configured of the electrophotographic member according to claim 4.

14. A transfer device comprising:
a transfer member configured of the electrophotographic member according to claim 5.

15. A transfer device comprising:
a transfer member configured of the electrophotographic member according to claim 6.

16. An image forming apparatus comprising:
an image holder;
a charging device that charges a surface of the image holder;
an electrostatic latent image forming device that forms an electrostatic latent image on the charged surface of the image holder;
a developing device that accommodates a developer containing a toner and develops the electrostatic latent image formed on the surface of the image holder with the developer to form a toner image;
the transfer device according to claim 10, that transfers the toner image onto a surface of a recording medium; and
a fixing device that fixes the toner image on the surface of the recording medium.

17. A method of forming the surface layer of the electrophotographic member according to claim 1, the method comprising:
forming the surface layer by a blade coating method.

18. A method of forming the surface layer of the electrophotographic member according to claim 1, the method comprising:
forming the surface layer by a dip coating method.

19. A method of forming the surface layer of the electrophotographic member according to claim 1, the method comprising:
forming the surface layer by a spray coating method.

20. A method of forming the surface layer of the electrophotographic member according to claim 1, the method comprising:
forming the surface layer by a ring coating method.
